(19) United States
(12) Patent Application Publication
(10) Pub. No.: US 2018/0128662 A1
(43) Pub. Date: May 10, 2018

(54) METHOD AND APPARATUS FOR DETERMINING THE MASS OF A FLUID FLOWING THROUGH A FLOW RATE METER IN A CONSUMPTION TIME INTERVAL

(71) Applicant: AVAGO TECHNOLOGIES GENERAL IP (SINGAPORE) PTE. LTD., Singapore (SG)

(72) Inventors: Walter Mehnert, Ottobrunn (DE); Thomas Theil, Feldafing (DE)

(21) Appl. No.: 15/860,502

(22) Filed: Jan. 2, 2018

Related U.S. Application Data
(63) Continuation of application No. 13/992,802, filed on Aug. 14, 2013.

(30) Foreign Application Priority Data
Jan. 6, 2011 (DE) 10 2011 008 010.4
Feb. 21, 2011 (DE) 10 2011 011 871.3

(51) Int. Cl. G01F 1/58; G01F 3/22; G01F 15/04; G01F 15/075

(52) U.S. Cl. CPC G01F 1/58; G01F 15/0755; G01F 15/046; G01F 3/227

(57) ABSTRACT

The mass of a fluid flowing through a flow rate meter at a temperature which fluctuates in a given temperature range is determined by driving an exciter magnet system through the fluid with an exact correlation between the fluid volume flowing there through and the movement path covered by the exciter magnet system, producing a measurement voltage pulse after each passage through a movement path corresponding to a unit volume of the fluid by means of a Wiegand wire and a coil surrounding same, at each measurement time charging a first energy storage means by electric energy contained in each measurement voltage pulse, and using same as operating energy for measurement of the instantaneous temperature of the fluid, producing a temperature value as an integral multiple of the smallest temperature measurement unit to be resolved and an integral count value including said temperature value, and adding same to a sum contained in a non-volatile storage means from the precedingly ascertained count values for forming an ongoing sum in the non-volatile storage means and passing same to a processor which can be supplied with external energy and which calculates therefrom the temperature-corrected delivery volume of the fluid.

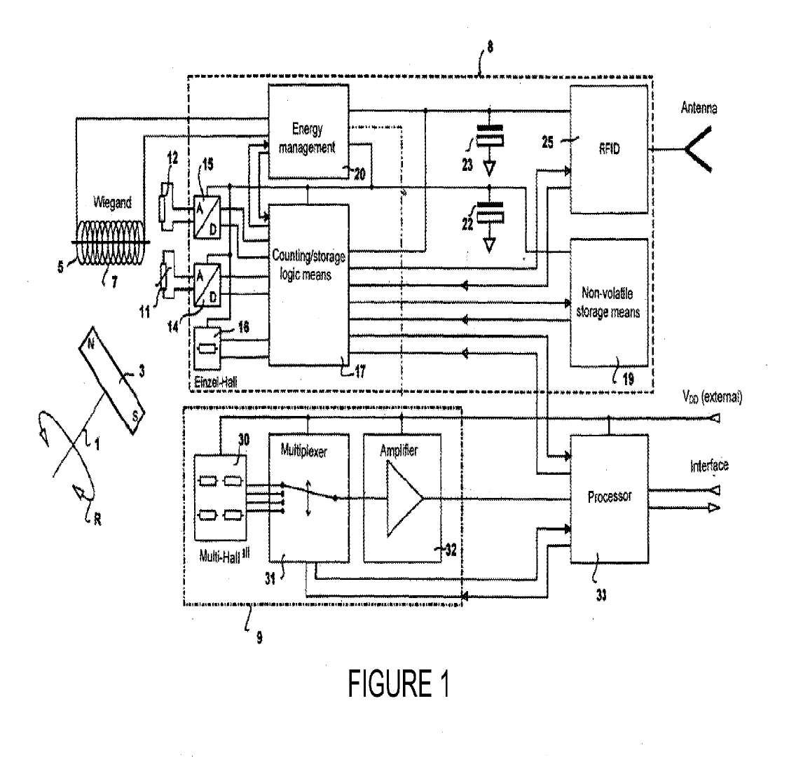

The invention concerns a method of determining the mass of a fluid flowing through a flow rate meter, in particular gas, as set forth in the classifying portion of claim 1, and an apparatus suitable for carrying out that method.

Flow rate meters are known, which serve to detect the amount of a gas or a liquid, or generally a fluid, which flows through same from a supplier to a consumer and to form a counter status which is read off at certain time intervals to ascertain the mass of the fluid which has flowed through the flow rate meter in the time interval preceding the reading-off operation, as that mass is uniquely correlated with the energy which is delivered to the consumer and which is stored in the fluid, on the assumption that the chemical and/or physical composition of the fluid does not change.

In the description hereinafter for the sake of simplicity reference is primarily made to gas meters or gas flow rate meters, but it should be expressly noted that the method according to the invention can also be used in the same manner for liquid flow rate meters.

Many of the gas flow rate meters which are usual at the present time are in the form of bellows-type meters, that is to say measurement chambers which are separated from each other by diaphragms are periodically filled and emptied. A joint linkage mechanism transmits the diaphragm movement to a crankshaft which drives two sliders which control the gas flow. Thus the gas flow is passed alternately through a bellows. The rotary movement of the linkage mechanism is transmitted by way of a magnetic coupling to a mechanical counting mechanism which generally cannot be reset to prevent attempted manipulation. The measurement chambers predetermine a unit volume V_{E} and the counter status of the counting mechanism is increased by one each time when a unit volume V_{E} has been delivered to the consumer.

The counter status is read off at selectable time intervals, for example yearly, and the amounts of fluid supplied to the consumer in question are billed as a multiple of the unit volume V_{E}, for example in liters or cubic meters. It is assumed in that respect that the pressure of the fluid flowing through the flow rate meter is constant at all times, that is to say it is of a fixedly predetermined value.

If then the fluid is also at a constant temperature which for example is equal to the usually employed reference temperature T₀=293 Kelvin (+20° C.), then the described measuring and billing method leads to completely correct results because then the unit volume V_{E} corresponds to a fluid unit mass M₀ which is exactly known in respect of its value and which is always the same. To ascertain the fluid mass M_{consumption} which has flowed through the flow rate meter between two counter status reading operations, it is then sufficient to multiply the change in counter status that has occurred by the unit volume V_{E} in order to obtain a volume value which represents an exact measurement of the amount of fluid delivered to the consumer or the energy stored therein.

In the general case however neither the temperature or the pressure of the fluid are constant with sufficient accuracy. Thus the former can vary in a defined range, for example between 253 Kelvin and 333 Kelvin (between −20° C. and +60° C.) while, when no particular measures are implemented, the pressure is related to atmospheric pressure which changes not only with the weather conditions but also depends on the height above sea level of the location at which the flow rate meter is used.

For the description hereinafter it is firstly assumed that technical measures ensure that the fluid pressure at the location of use of the flow rate meter is equal to a known constant reference pressure p₀. The problem which then remains is that, in the delivery of the unit volume V_{E} to the consumer, that respectively triggers off a counting step, a fluid mass M_{M} which changes greatly with the temperature T_{M} prevailing at the respective measurement time is delivered so that simple multiplication of the count value and the unit volume V_{E} does not lead to usable results.

In other words: if the temperature T_{M} of the fluid at the measurement time is lower than T₀, then the fluid is of greater density and a greater mass of fluid is delivered to the consumer per unit volume V_{E}, than at the reference temperature T₀; conversely, if the temperature T_{M} of the fluid at the measurement time is higher than T₀, then the fluid is of lower density and the consumer receives a smaller mass of fluid per unit volume V_{E}.

In order nonetheless to be able to implement correct ascertainment of the delivered amount of fluid and to be able to express same in volume units, it is necessary, at least in each measurement value detection operation, to measure the absolute temperature T_{M} of the fluid and to take account thereof in forming the measurement value, in that, by means of the general gas equation, on the basis of the fluid mass M_{M} contained in the unit volume V_{E} at the temperature T_{M}, a delivery volume V₀ is calculated, which that mass M_{M} would have assumed if it had had the reference temperature T₀ when flowing through the flow rate meter.

In regard to the measurement temperature T_{M}, the following applies in accordance with the general gas equation:

p_{M}V_{E}=n_{M} R T_{M} (1)

while in regard to the reference temperature T₀ the following applies:

p₀V₀=n₀ R T₀ (2)

wherein n_{M} R stands for the fluid mass contained in the unit volume V_{E} at the measurement temperature T_{M} and n₀R stands for the fluid mass contained in the unit volume V_{E} at the reference temperature T₀.

To obtain the above-described delivery volume V₀ corresponding to the fluid mass n_{M} R equation (1) is divided by equation (2) and in accordance with the measurement principle n_{M} R is made equal to n₀ R and, because the pressure p is assumed to be constant, it is deemed that p_{M}=p₀, and this gives:

V₀/V_{E}=T₀/T_{M} (3)

Equation (3) can be resolved in accordance with the delivery volume V₀ of interest:

V₀=V_{E}T₀/T_{M} (4)

By means of a processor or a computing circuit it would therefore be readily possible at each measurement time to calculate from the measured temperature T_{M} the delivery volume V₀ corresponding to the fluid mass M_{M} which has just flowed through, as a multiple or part of V_{E}, as T₀ is an established constant.

Now, it is not only desirable but often essential for safeguard reasons for the measurement and storage procedures in respect of flow rate meters to be implemented independently of an external power supply or battery as the former is not available in manipulation-safeguarded fashion at any time at every measurement location and the use of the latter involves a high level of checking complication and expenditure and entails functional safeguard problems.

In accordance with the invention therefore the energy required for the measurement and storage procedures is obtained from the kinetic energy of the fluid by means of an autonomous position sensor which can be in the form of a linear sensor or revolution counter, as is described for example in DE 10 2007 039 050 A1.

For that purpose there is provided an exciter magnet system which for example in the case of bellows-type meters is either reciprocated with the sliders or is mounted on a rotor which is caused to rotate by way of a crankshaft arrangement or the like, by the fluid flow to be detected. It is crucial that there is an exact correlation between the fluid volume which has flowed through the flow rate meter or its measurement chamber or chambers and the portions of motion through which the exciter magnet system has passed.

The following description refers to a preferred situation where the exciter magnet system is mounted on a rotor and is thus part of a revolution counter. The method according to the invention however is not restricted thereto and can be used in an entirely similar fashion if the number of fluid unit volumes V_{E} delivered is measured by means of a linear sensor arrangement. The fluid unit volume V_{E} is different from one device to another and has to be determined in a calibration operation. The device-specific calibration constant resulting therefrom is contained in the respectively employed V_{E}.

Whenever the rotor of the rotary sensor variant has passed through a predeterminable angle segment Δφ_{M} which can be for example of a value of 360°, measurement value detection takes place. The corresponding moment in time is referred to herein as the measurement time. However any other values, in particular 180° or 60°, can also be adopted for the angle segment Δφ_{M}. At any event a fluid unit volume V_{E} defined by the size of the measurement chamber or chambers must flow through the flow rate meter so that the rotor rotates through the angle segment Δφ_{M}.

As a Wiegand or pulse wire with a coil wound on the wire is so arranged in the field of the exciter magnet system that at least whenever the rotor or the flow rate meter has passed through the angle segment Δφ_{M}, that is to say at each measurement time, a measurement voltage pulse is generated in the coil, at least a first energy storage means of an energy storage unit can be charged up, which supplies energy to a temperature measuring unit serving to measure the fluid temperature, a non-volatile storage means in which the measurement values are formed or stored, and at least a part of a corresponding electronic control and processing means, at least until the respective last measurement value is reliably stored.

It will be noted however that the electric energy branched from the kinetic energy of the fluid in that way in the individual voltage pulses is not sufficient at the time to operate at each measurement time a processor, by means of which the division shown in equation (4) and required in each measurement value detection operation by T_{M} can be performed.

In accordance with a first aspect of the invention therefore the division which is actually required when using a temperature sensor with an output voltage directly proportional to the absolute temperature T_{M}, in accordance with equation (4), is converted by a mathematical approximation method into summing of whole numbers, which can be effected without the assistance of a processor with a logic control means which has only a low energy requirement and can therefore be fed from the energy of a single voltage pulse.

If in equation (4) T_{M} is replaced by T₀±ΔT, that gives:

$${V}_{0} = {V}_{E} \frac{{T}_{0}}{{T}_{0} \pm Δ T} = {V}_{E} \frac{1}{1 \pm \frac{Δ T}{{T}_{0}}} \qquad ( 5 )$$

If ΔT is small in comparison with T₀, then the following approximately applies:

$$\begin{matrix}{V}_{0} \approx {V}_{E} ( 1 ∓ \frac{Δ T}{{T}_{0}} ) \\ or & ( 6 ) \\ {V}_{0} {T}_{0} \approx {V}_{E} ( 2 {T}_{0} - {T}_{M} ) & ( 7 )\end{matrix}$$

Since, as already mentioned, in the case of a flow rate meter operating in accordance with the invention, the measurement temperature T_{M} can vary for example between 253 Kelvin and 313 Kelvin, the condition that ΔT is to be small in comparison with T₀ does not apply in the entire temperature range, and it is necessary to introduce a correction constant ρ≤1:

$${V}_{0} \frac{{T}_{0}}{{V}_{E}} \approx ( 1 + \frac{1}{ρ} ) {T}_{0} - ρ {T}_{M} \qquad ( 8 )$$

For the fluid delivery volume V_{consumption} which is relative, that is to say which is related to the fluid unit volume V_{E}, which has flowed through the flow rate meter in a period of time in which r measurement value detection operations have taken place, the following then applies:

$${V}_{consumption} {T}_{0} \approx r ( 1 + \frac{1}{ρ} ) {T}_{0} - {\sum }^{r} ρ {T}_{M} \qquad ( 9 )$$

If, to achieve integral temperature measurement values, a constant a representing the resolution of temperature measurement is introduced, then equation (9) can be transformed into:

$$α \frac{{V}_{consumption} {T}_{0}}{ρ} \approx r α ( \frac{1 + ρ}{{ρ}^{2}} ) {T}_{0} - {\sum }^{r} α {T}_{M} \qquad ( 10 )$$

or, as T₀, α and ρ are known constant parameters so that αT₀/ρ can be referred to as the first constant K₁ and (1+ρ)T₀α/ρ² can be referred to as the second constant:

$${V}_{consumption} {K}_{1} \approx {rK}_{2} - {\sum }^{r} α {T}_{M} \qquad ( 11 )$$

or alternatively

$${V}_{consumption} {K}_{1} \approx {\sum }^{r} ( {K}_{2} - α {T}_{M} ) . \qquad ( 12 )$$

In both cases admittedly the product αT_{M} must be formed in each measurement time by means of the available energy of a single pulse of the coil wound around the Wiegand or pulse wire, which however can be effected by means of an analog/digital converter involving a low power requirement, with the resolution capability α, which directly supplies that product when it is fed with the analog signal supplied by a linearly operating temperature sensor.

α specifies how far the unit, for example Kelvin, is resolved. With a resolution of 0.1 Kelvin, α=10.

When using equation (11) it is therefore sufficient for the integral values αT_{M} respectively occurring at the measurement times to be stored as an ongoing sum in a non-volatile storage means and for the counter status of a non-volatile counter to be increased by 1 in order to store the number r of the measurement value detection operations effected in a time interval considered.

The ongoing sum and the counter status r of the non-volatile counter can then be passed at any selectable transmission times to a processor which is preferably supplied by means of external energy and which converts it into the respective delivery volume V_{consumption}. Those transmission or reading-out processes correspond to the operations of reading off the known mechanical counting mechanisms, set forth in the opening part of this specification, and they can also be effected in fixedly predetermined time intervals. As however there is no need for them to be carried out by an operator going to the flow rate meter in question, substantially shorter spacings in respect of the transmission times are also possible. They can either be predetermined in accordance with a fixed time pattern and/or they can be triggered by a demand on the part of the receiver side or the consumer.

As a flow rate meter according to the invention is protected from manipulation operations from the exterior, it is possible in principle for the ongoing sum in the non-volatile storage means and the counter status r of the non-volatile counter to be set back to zero after each transmission to the processor. That gives the advantage that the respective delivery volume V_{consumption} directly denotes the amount of fluid which has flowed to the consumer since the preceding transmission time.

Extrapolation of the amount of fluid delivered to the consumer since the beginning of supply is possible as the normal situation with the method according to the invention in that the ongoing sum and the count value r are not reset either at the flow rate meter itself or at the receiver of the transmitted data.

The time interval which precedes the respective transmission time and for which the processor calculates the mass of fluid which has flowed through the flow rate meter is therefore either the time interval which has elapsed between the last and the penultimate transmission time or it is the time interval which has elapsed from the beginning to the last transmission time.

When using equation (12) the decimal places of K₂ can be disregarded without major error so that the values K₂-αT_{M} which respectively occur at the measurement times are whole numbers and can be stored in the non-volatile storage means as an ongoing sum. Difference formation can be implemented with a computing system involving a low level of power requirement. Detection and storage of the count value r is not required here. Definitive calculation of the delivery volume V_{consumption} is again effected at the end of the time interval being considered, after reading off just the ongoing sum which is divided by K₁ by means of a processor supplied with external energy.

In the equations (8) to (12), the “≈” sign can be replaced by the “=” sign if levels of accuracy ≥0.5% are admissible.

Another possible way of producing the values to be stored in the non-volatile storage means as an ongoing sum involves using a non-linear temperature sensor which supplies an output voltage U_{M} inversely proportional to the temperature T_{M}, as is possible for example by means of an NTC suitably connected to additional resistors.

Equation (4) then becomes:

V₀=V_{E} T₀ U_{TM} (13)

or, if U_{Mmin} denotes the voltage value occurring at the lowest temperature to be measured and the currently measured temperature T_{M} is represented by U_{Mmin}+ΔU_{T};

$$\frac{{V}_{0}}{{V}_{E} {T}_{0}} = {U}_{TM} = {U}_{min} + Δ {U}_{TM} \qquad ( 14 )$$

The operation of ascertaining the delivery volume V_{consumption} is then effected in accordance with the equation:

$${K}_{4} {V}_{consumption} = r α {U}_{min} + {\sum }^{r} α Δ {U}_{TM} \qquad ( 15 )$$

(with counting of the measurement value detection operations per time interval considered and storage and transmission of the counter status r in question) or in accordance with equation:

$${K}_{4} {V}_{consumption} = {\sum }^{r} ( α {U}_{min} + α Δ {U}_{TM} ) = {\sum }^{r} α {U}_{tm} \qquad ( 16 )$$

(without counting of the measurement value detection operations per time interval considered and without production, storage and transmission of a corresponding counter status r)

If the detected and stored value or values has or have been passed to a processor supplied with external energy it can ascertain the delivery volume V_{consumption} of interest in the case of equation (15) from the continuously stored sum

$${\sum }^{r} α Δ {U}_{TM}$$

by the addition of rαU_{Mmin} and division by K₄, wherein K₄=α/V_{E}T₀. When using equation (16) only the ongoing sum

$${\sum }^{r} α {U}_{TM}$$

is communicated to the processor and divided by K₄ thereby. In this case also α is a factor which ultimately does not influence the measurement value and which only serves to produce whole numbers from the measurement values ΔU_{M} occurring under some circumstances as multiples of fractions of a degree. If the measurement values ΔU_{M} are obtained only in whole Celsius degree values, so α=1, if they are tenths of degree values α=10 and so forth.

If no device for keeping the fluid pressure constant is provided then it is measured in accordance with the invention. If U_{pM} is the voltage delivered by the pressure sensor used, then similarly to equation (13) that gives:

$$\frac{{V}_{0} {p}_{0}}{{V}_{E} {T}_{0}} = {U}_{TM} {U}_{pM} \qquad ( 17 )$$

If in this case also two factors α and β corresponding to the degree of measurement resolution are introduced, which produce integral values αU_{TM} and βU_{pM} from the voltage values U_{TM} and U_{pM}, then similarly to equation (16) that gives:

$${K}_{5} {V}_{consumption} = {\sum }^{r} α β {U}_{TM} {U}_{pM} \qquad ( 18 )$$

wherein K₅=αβp₀/V_{E}T₀. It is therefore sufficient with the energy available for each measurement pulse in the first energy storage means to form the product αU_{TM}βU_{pM} and to store it as the ongoing sum

$${\sum }^{r} α β {U}_{TM} {U}_{pM}$$

in the non-volatile storage means, from which it can be passed to the processor supplied with external energy and which divides it by K5 to obtain the delivery volume V_{consumption} which is of interest and which is corrected both in relation to temperature changes and also pressure changes and which represents an accurate measurement of the fluid mass delivered to the consumer.

In the case of many flow rate meters the mechanical arrangement is such that the rotor can rotate only in one direction. In use situations in which rotor rotation is possible in both directions, a magnetosensitive element, for example a Hall element, is additionally arranged in the field of the exciter magnet system, the output signal of which serves for detecting the direction of rotation, as is described for example in DE 10 2008 051 479 A1 and which is also supplied with electric energy by the first energy storage means.

By means of a Hall element arrangement which can be supplied with external energy and which is equally arranged in the field of the exciter magnet system the angle segment Δφ_{M} can be finally resolved, as is know for example from above-mentioned DE 10 2007 039 050 A1. That fine resolution can be used for calibration purposes and/or for detecting leaks on the consumer side.

The exciter magnet system can include a plurality of permanent magnets so that the coil wound on to the Wiegand or pulse wire between the measurement voltage pulses delivers further voltage pulses which charge a further energy storage means in the form an autonomous energy source of the energy storage unit, in which energy from a plurality of those further voltage pulses is cumulated, that energy being sufficient to send the value of the ongoing sum stored in the non-volatile storage means to a remotely arranged receiver, from time to time, at which there is then disposed the processor which is supplied with external energy and which performs the calculation of the delivery volume V_{consumption}. It is also possible for the further energy storage means of the energy storage unit even to supply energy to that processor or to a processor which is in the flow rate meter and which performs those calculations.

Preferably the exciter magnet system includes two permanent magnets with a shielding return body, as described in DE 10 2007 039 050 A1. That shielding means that the flow rate meter can be effectively protected from attempted manipulation which is effected by means of externally applied magnetic fields in order for example to inhibit or brake the movement of the exciter magnet system.

Preferably an FRAM storage means or an MRAM storage means is used as the non-volatile storage means.

These and further advantageous configurations of the method according to the invention are recited in the appendant claims.

The invention is described hereinafter by means of an embodiment by way of example with reference to the drawing; therein the single FIGURE shows a schematic block circuit diagram of the most essential components, serving to carry out the method according to the invention, of a flow rate meter on the basis of an autonomous rotary sensor.

To be able to obtain the electric energy required for carrying out the necessary measurement and storage procedures from the kinetic energy of a flowing fluid, there is provided an exciter magnet system 1 which is represented in the FIGURE by a permanent magnet and which in the illustrated embodiment is mounted on a rotor of which only the axis of rotation 3 is indicated in the FIGURE. As indicated by the arrow R, the rotor is caused to rotate by the fluid flow to be detected, by means of a suitable mechanical device (not shown in the FIGURE), in such a way that there is an exact correlation between the fluid volume flowing through the flow rate meter or its measuring chamber or chambers, and the rotary angle covered by the rotor. Disposed in the field of the exciter magnet system 1 is a Wiegand arrangement comprising a Wiegand or pulse wire 5 and a coil 7 which is wound thereon and in which a voltage pulse in induced whenever the exciter magnet system 1 passes through certain angle positions. If the exciter magnet system 1 only consists of a single permanent magnet, then two such voltage pulses are obtained in each full revolution of the rotor, but it is possible for example for six or ten such pulses also to be produced in each full revolution by the use of a plurality of pairs of magnetic poles.

For the example described here it is assumed that one of the voltage pulses produced in the respective full revolution serves as a measurement voltage pulse, that is to say whenever the rotor has passed through an angle segment Δφ_{M}, of 360°, corresponding to a unit volume V_{E} of the fluid that has flowed through the flow rate meter, the measurement and storage procedures described hereinafter are performed. The moment at which such a measurement voltage pulse occurs is referred to in the present context as the measurement time.

The circuit units shown in the FIGURE can be divided into two mutually partially overlapping groups 8 and 9, of which the first is enclosed by a rectangle shown in broken lines and the second is enclosed by a rectangle shown in dash-dotted lines.

Of the circuit units and components in the first group 8, the analog/digital converters 14 and 15 respectively associated with the temperature sensor 11 and the pressure sensor 12, the single Hall element 16 possibly provided for detecting the direction of rotation of the rotor, the counting and storage logic means 17, the non-volatile storage means 19 and the energy management circuit 20 operate each time that there occurs a measurement voltage pulse which charges a first energy storage means 22 which is formed in the FIGURE by a capacitor and which provides that the required electric working energy is available to the above-mentioned units sufficiently long that they ascertain the currently prevailing measurement values for the fluid temperature T_{M} and the fluid pressure p_{M} and digitize same and can store the integral count values βU_{pM} and αU_{TM} formed from those measurement values in the counting and storage logic means 17 as an ongoing sum in the non-volatile storage means 19, in which there is possibly also stored a counter status r which is ascertained by the counting and storage logic means 17 and which specifies what is the ordinal number of the measurement voltage pulse, that has occurred in a delivery time interval being considered.

Production of the ongoing sum is now to be elucidated by a numerical example for the situation where the pressure can be viewed as constantly equal to p₀. If it is assumed that, by virtue of a suitable resolution on the part of the analog/digital converter 14, the temperature measurement value U_{TM} falls in tenths of a degree and is for example 293.5 Kelvin after passing through a full revolution of the rotor, triggering a measurement voltage pulse, that value is thus multiplied by α=10, thus giving an integral count value of 2935 which to form the ongoing sum is added to the numerical value (for example 576365) contained in the non-volatile storage means 19 so that the new ongoing sum now contained in the non-volatile storage means 19 is 579300. If then, when the next measurement voltage pulse occurs, the temperature has increased by two tenths of a degree to 293.7 Kelvin, then 2937 is obtained as the last integral count value and 582237 is obtained as the last ongoing sum.

In contrast to a conventional flow rate meter whose counting mechanism continues to count by “1” at each passage through the measurement angle segment Δφ_{M} of for example 360°, in accordance with the invention the ongoing sum in the non-volatile storage means 19 is increased on each occasion by an integral count value which changes in dependence on the fluid temperature prevailing at the measurement time so that that ongoing sum contains all items of information required to calculate the fluid mass delivered to the consumer. A corresponding consideration also applies in respect of changing pressure measurement values if the fluid pressure value UₚM detected at the respective measurement time can vary.

If it is assumed that the energy delivered by a measurement voltage pulse is just sufficient to perform the measurement and storage tasks described, which occur at each measurement time, it is then provided that the energy of voltage pulses which are produced between the measurement voltage pulses and which do not trigger any measurement and storage procedures of that kind is cumulated in a second energy storage means 23 which for example is also formed by a capacitor and which at selectable moments in time supplies energy to a transmitter 25 which can operate with radio frequency, infrared light, ultrasound or any other transmission energy, in order for example to wirelessly send the last value of the ongoing sum stored in the non-volatile storage means 19 and optionally the counter status r to a remotely arranged receiver at which then, with an external energy supply, implementation of the calculations required for ascertaining the fluid mass delivered to the consumer in a respective measurement time interval can be effected by means of a processor, a p-controller, a computer or the like.

If however measurement voltage pulses contain more energy than is needed for the respectively occurring measurement and storage tasks, that excess energy can also be cumulated in the further energy storage means 23 and used in the above-depicted fashion.

All circuit portions belonging to the first group 8 operate totally autonomously and do not require either a battery or any other external energy supply. Preferably they are combined together in an IC which can also be in the form of a hybrid circuit. In particular the first energy storage means 22 can be integrated in that IC. In general the temperature sensor is a separate component.

In comparison, a supply with electric energy solely from the first energy storage means 22 is not adequate for the components or circuit units belonging to the second group 9, namely a Hall probe arrangement 30 including a plurality of Hall elements, a multiplexer 31 and an amplifier 32. They therefore require an additional energy source, as is also described in greater detail hereinafter.

The processor 33 shown in the FIGURE can either be a component of the circuit arrangement disposed directly at the flow rate meter; it is then either to be attributed to the group 9, or it is supplied with electric energy from the further energy storage means 23 so that, from the respectively last value of the ongoing sum stored in the non-volatile storage means 19, it calculates the corresponding values of the delivered mass of fluid and passes same to the transmitter 25 which then sends them for example wirelessly to a remotely arranged receiver. If a receiver can receive the data from a plurality of transmitters (network arrangement) then each of the transmitters sends a dispatcher address identifying it, together with the data required for calculating the delivery volume V_{consumption}.

In accordance with a further alternative the processor 33 can be identical to the above-mentioned processor which is arranged at a remotely disposed receiver and for which an external energy supply is provided in any case. The required data which are then transmitted also then include the constants K₁ to K₃ with the included calibration data.

The Hall probe arrangement, like the Wiegand or pulse wire 5 and the coil 7 wound thereon, is disposed in the field region of the exciter magnet system 1 and serves to cause fine resolution of the angle segments predetermined by the pairs of magnetic poles of the exciter magnet system 1, as is known from the above-mentioned state of the art (multi-turn). The multiplexer 31 serves for single-channel processing of the output signals of the individual Hall elements of the Hall probe arrangement 30, which are amplified in the subsequent amplifier 32 and then fed to the processor 33 which ascertains therefrom in per se manner fine angle values which more precisely describe the respective rotor position.

For the purposes of that fine resolution there is on the one hand facilitated calibration of the flow rate meter according to the invention, which is implemented at the factory before first bringing the system into operation, in which case the external voltage V_{DD} is readily available.

In addition fine resolution can be used for tracing leaks, through which only very small amounts of fluid issue on the consumer side of the flow rate meter. For that purpose a maintenance operative supplies the circuit arrangement of the flow rate meter with external energy for a period of time which for example can be of the order of magnitude of some minutes, and, by means of the fine resolution arrangement, observes whether the angular position of the rotor changes slightly, which points to the presence of a leak, or not. The “external energy” can be made available in the most widely varying ways, for example by using a battery or a solar cell operated with ambient light.

Instead of the above-mentioned Hall elements or Hall probes, it is also possible to use other magnetosensitive components, GMR-sensors (GMR—giant magneto resistance).

For reasons of space and costs, implementation of the apparatus according to the invention is generally preferred with a single Wiegand module, comprising a Wiegand or pulse wire with a coil wound thereon. It is however also possible to envisage solutions with two or more Wiegand modules in place of a Wiegand module supplemented by an additional magnetosensitive element.

1-13. (canceled)

14. A method of determining a mass of a compressible gas flowing through a flow rate meter, the method comprising:
flowing compressible gas through the flow rate meter such that a component of an exciter magnet system is moved through a predetermined movement path;
in response to the component completing a movement through the predetermined movement path, causing a measurement voltage pulse to be generated with the exciter magnet system, wherein the measurement voltage pulse is generated at a measurement time, and wherein the measurement voltage pulse comprises a first amount of electric energy;
charging, at the measurement time, a first energy storage device with a portion of the first amount of electric energy; and
using, at the measurement time, energy stored in the first energy storage device to: (i) measure an instantaneous absolute temperature or a parameter derived therefrom of the compressible gas flowing through the flow rate meter; (ii) produce a temperature value derived from the instantaneous absolute temperature or the parameter derived therefrom; (iii) produce an integer count value including the temperature value; and (iv) add the integer count value to a sum of count values contained in a non-volatile memory.

15. The method of claim 14, further comprising:
at a selected transmission time that occurs after the measurement time, providing electric energy to a processor thereby enabling the processor to access the sum of count values contained in the non-volatile memory and then generate a message that is transmittable via a transmitter, wherein the message contains the sum of count values.

16. The method of claim 15, further comprising:
at the selected transmission time, enabling the processor to transmit the message via the transmitter.

17. The method of claim 16, wherein energy stored in the first energy storage device is further used, at the measurement time, to: (v) measure a pressure prevailing in a unit volume through which the compressible gas has flowed; (vi) produce a pressure value based on the measured pressure; and (vii) modify the integer count value to include an accounting for the pressure value.

18. The method of claim 14, wherein the instantaneous absolute temperature is measured by a temperature sensor whose output is directly proportional to the instantaneous absolute temperature.

19. The method of claim 14, wherein energy stored in the first energy storage device is further used, at the measurement time, to determine a counter state.

20. The method of claim 14, further comprising:
determining a direction of rotation of the component of the exciter magnet system with a Hall element, wherein the Hall element is supplied with electric energy by the first energy storage device.

21. The method of claim 14, further comprising:
at the measurement time, converting an analog output signal of a temperature sensor to a digital value that corresponds to the instantaneous absolute temperature.

22. The method of claim 14, wherein the exciter magnet system includes at least two exciter magnets which are shielded outwardly by a ferromagnetic return yoke body.

23. The method of claim 14, wherein the measurement voltage pulse is produced with a Wiegand or pulse wire.

24. The method of claim 14, further comprising:
at times other than the measurement time and prior to the component of the exciter magnet system completing the movement through the predetermined movement path, using motion of the component to produce additional voltage pulses that comprise a second amount of electric energy; and
charging a second energy storage device with a portion of the second amount of electric energy.

25. The method of claim 14, wherein the first energy storage device comprises a capacitor.

26. An apparatus configured to determine the mass of a compressible gas whose instantaneous absolute temperature can fluctuate in a given temperature range, the apparatus comprising:
a flow rate meter comprising a unit volume through which the compressible gas is allowed to pass;
an exciter magnet system including a component that is moveable in response to the compressible gas pass through the flow rate meter, wherein there exists an exact correlation between an amount of the compressible gas flowing through the unit volume and a length of a predetermined movement path of the component;
a Wiegand or pulse wire arranged in proximity of the exciter magnet system that produces a measurement voltage pulse when the component has completed the predetermined movement path, wherein the measurement voltage pulse is produced at a measurement time; and
a first energy storage device in electrical communication with the Wiegand or pulse wire that is charged with the measurement voltage pulse, wherein electric energy contained in the first energy storage device is used at the measurement time to provide power to each of the following: (i) a temperature sensor that is configured to measure an instantaneous absolute temperature or a parameter derived therefrom of the compressible gas flowing through the flow rate meter; (ii) a calculation device configured to produce a temperature value derived from the instantaneous absolute temperature or the parameter derived therefrom as well as produce an integer count value including the temperature value; and (iii) non-volatile computer memory configured to have the integer count value added thereto as a current sum of count values already contained in the non-volatile computer memory.

27. The apparatus of claim 26, further comprising:
a processor configured to, at a selected transmission time that occurs after the measurement time, access the current sum of count values from the non-volatile computer memory and then generate a message that contains the current sum of count values.

28. The apparatus of claim 27, further comprising:
a transmitter configured to transmit the message to a receiver.

29. The apparatus of claim 28, further comprising:
a second energy storage device configured to receive electric energy from the exciter magnet system and with the electric energy stored therein power the processor and transmitter.

30. The apparatus of claim 26, wherein energy stored in the first energy storage device is further used, at the measurement time, to: (v) measure a pressure prevailing in a unit volume through which the compressible gas has flowed; (vi) produce a pressure value based on the measured pressure; and (vii) modify the integer count value to include an accounting for the pressure value.

31. The apparatus of claim 26, further comprising:
a temperature sensor whose output is directly proportional to the instantaneous absolute temperature.

32. The apparatus of claim 26, wherein energy stored in the first energy storage device is further used, at the measurement time, to determine a counter state.

33. The apparatus of claim 26, further comprising:
a Hall element supplied with electric energy by the first energy storage device to determine a direction of rotation of the component.

34. The apparatus of claim 26, further comprising:
an analog to digital converter that converts an output signal of a temperature sensor to a digital value that corresponds to the instantaneous absolute temperature.
